(19) United States
(12) Patent Application Publication
(10) Pub. No.: US 2026/0307337 A1
(43) Pub. Date: Oct. 8, 2026

(54) METHODS OF MAKING ROTARY ACOUSTIC HORNS

(71) Applicant: 3M INNOVATIVE PROPERTIES COMPANY, St.Paul, MN (US)

(72) Inventors: Alexander P. Flage, Cottage Grove, MN (US); Ryan D. Kracht, West St. Paul, MN (US); Satinder K. Nayar, Woodbury, MN (US); Timothy J. Rowell, St.Paul, MN (US); Verlin W. Schelhaas, New Richmond, WI (US)

(21) Appl. No.: 19/482,205

(22) PCT Filed: Apr. 29, 2024
(86) PCT No.: PCT/IB2024/054152

§ 371 Date: Nov. 6, 2025

Related U.S. Application Data
(60) Provisional application No. 63/504,329, filed on May 25, 2023.

(51) Int. Cl. B29C 65/08; B06B 3/00; B22F 7/06

(52) U.S. Cl. CPC B29C 65/085; B06B 3/00; B22F 7/062

(57) ABSTRACT

Methods of using metallurgical fusion to join multiple horn segments to a unitary rotary acoustic horn are described. Rotary acoustic horns comprising plurality of segments joined by metallurgical fusion are also described.

### FIELD

The present disclosure relates to the use of metallurgical fusion to bond horn segments to form a unitary rotary acoustic horn. Rotary acoustic horns prepared by such methods are also described.

### SUMMARY

Briefly, in one aspect, the present disclosure provides methods of making rotary acoustic horns. The first horn segment comprises a first shaft having a first axial input end surface and a first axial output end surface, and a first horn core mechanically coupled to the first shaft and comprising a first circumferential welding surface integral to the first horn core. The second horn segment comprises a second shaft having second axial input end surface and a second axial output end surface, and a second horn core mechanically coupled to the second shaft and comprising a second circumferential welding surface integral to the second horn core. The first horn segment is metallurgically fused to the second horn segment by metallurgically fusing the first axial output end surface of the first shaft to the second axial input end surface of the second shaft to form an integral shaft.

In another aspect, the present disclosure provides rotary acoustic horns comprising a first horn segment comprising a first shaft having a first axial input end surface and a first axial output end surface, and a first horn core mechanically coupled to the first shaft and comprising a first circumferential welding surface integral to the first horn core; and a second horn segment comprising a second shaft having second axial input end surface and a second axial output end surface, and a second horn core mechanically coupled to the second shaft and comprising a second circumferential welding surface integral to the second horn core. The first axial output end surface of the first shaft is metallurgically fused to the second axial input end surface of the second shaft to form an integral shaft.

The details of one or more aspects of the invention are also set forth in the description below. Other features, objects, and advantages of the invention will be apparent from the description and from the claims.

### BRIEF DESCRIPTION OF THE DRAWINGS

FIGS. 1A-1C illustrate various views of a first horn segment.

FIGS. 2A-2C illustrate various views of a second horn segment.

FIGS. 3A-3B illustrate various views of the first horn segment metallurgically fused to the second horn segment with a gap.

FIG. 4 is a cross-sectional view of a third horn segment.

FIG. 5 is a cross-sectional view of the second horn segment metallurgically fused to a third horn segment.

### DETAILED DESCRIPTION

Many uses of ultrasonic energy for bonding and cutting thermoplastic materials involve ultrasonic horns or tools. A horn, also called a sonotrode, is an acoustical tool usually having a length of an integer multiple of one-half of the horn material wavelength that transfers mechanical vibratory energy to the part. Exemplary horn materials include aluminum, titanium, or steel, which typically have material wavelengths of approximately 25 cm for a vibration frequency of 20 kHz. Horn displacement or amplitude is the peak-to-peak movement of the weld face of the horn. The ratio of horn output amplitude to the horn input amplitude is termed gain. Gain is a function of the ratio of the mass of the horn at the vibration input and output sections.

In acoustic welding, such as ultrasonic welding, two parts to be joined (typically thermoplastic parts) are placed directly below an ultrasonic horn. Continuous ultrasonic welding is typically used for sealing fabrics, films, and other parts. In this mode, typically the ultrasonic horn is stationary, and the parts are moved beneath it. Scan welding is a type of continuous welding in which the parts are scanned beneath one or more stationary horns. In transverse welding, both the table over which the parts are positioned, and the part being welded remain stationary with respect to each other while moving underneath the horn or while the horn moves over them.

In plunge welding, the horn plunges (travels toward the parts) and transmits vibrations into the adjacent part. The vibrations travel through this part to the interface of the two parts. Here, the vibrational energy is converted to heat due to intermolecular friction that melts and fuses the parts. When the vibrations stop, the parts solidify under force, producing a weld at the joining surfaces.

Generally, bar horns comprise a horn body mounted to a shaft at one end and having a weld face at the opposite end. Generally, the amplitude direction of the mechanical vibrations at the weld face of a bar horn is parallel to the direction of the mechanical vibrations applied through the shaft. As a result, the bar horn experiences tensile and compressive forces parallel to the direction of the applied mechanical vibrations. The tensile and compressive forces result in periodic vibrations of the weld face moving it closer to and further from an underlying stack of substrates. Generally, there is a desire to control the amplitude of the vibration across the length of the weld face, e.g., to provide a substantially uniform amplitude across the weld face. Because the horn body of a bar horn can be easily accessed without interference from or damage to its weld face, complex geometries can be formed (e.g., molded or machined) into the body to modify the spatial distribution of mass in the body and thereby tailor the amplitude of vibrations across the weld face.

Rotary acoustic horns comprise a horn core mounted to shafts at both ends and circumferentially surrounded by a weld face. Although these may be separate parts that are joined (e.g., welded) together, often the horn may be an integral component. That is, in some cases, the weld face is integral to and forms the outer boundary of the horn core. Rotary acoustic horns differ from bar horns in that their weld faces expand and contract in the radial direction, perpendicular to the direction of the mechanical vibrations applied to the shaft of the horn. As a result, substantial forces can be developed in the weld face. In addition, it is often desirable to have the weld face extend the full length of the horn core, e.g., to maximize the working area of the acoustic horn. However, in such cases, the weld face may prevent access to portions of the horn core limiting the complexity of the geometries that can be formed in the horn core, thereby restricting the ability to tailor the amplitude of vibrations across the weld face.

For example, U.S. Pat. No. 5,707,483 (“Rotary Acoustic Horn,” Nayar et al.) describes rotary acoustic horn with undercuts formed below the weld face of the welding portion. However, all undercuts are formed on the ends of the welding portion. Individual rotary acoustic horns can be stacked such that the center-to-center distance between adjacent weld faces is either one-half wavelength of the horn material or one wavelength of the horn material. The resulting acoustical tool has an axial length of an integer multiple of one-half wavelength of the horn material.

U.S. Pat. No. 5,645,681 (Gopalakrishna, et al.) also describes stacked rotary acoustic horns either in series or in parallel. As defined in Gopalakrishna, et al., horns are classified as “stacking in series” when the output of one horn in the axial direction becomes the input to the next horn such that the first horn drives the second horn. Each horn has an acoustic length equal to an integer multiple of the half-wavelength of the horn material.

Adjacent horns have been joined by mechanical fasteners (e.g., threaded studs) connecting adjacent shafts. For this to be effective to transfer the vibrational energy output of one horn in the axial direction as the input to the next horn such that the first horn drives the second horn, the horns must be joined at or near the antinode of the input axial vibrations parallel to the shaft. This location corresponds to the nodes of the radial output vibrations perpendicular to the shaft, limiting design flexibility. Also, this arrangement can result in large stresses in the connector, often leading to failure.

Unacceptable weld gaps can arise in a welded substrate created by large gaps in the weld face between adjacent horns. To overcome this issue, Gopalakrishna, et al. describe staggering several arrangements of multiple rotary horns. Alternatively, a cylindrical shell has been used to surround multiple horns, bridging the gap between weld faces to create a continuous weld face. However, the large forces occurring at the weld face during operation often lead to failure (e.g., horn fracture) at the shell-horn interface.

There is a need for improved methods to form rotary acoustic horns. For example, there is a need for methods suitable to produce rotary acoustic horns that can be tailored to specific frequencies, amplitude profiles, and applications. There is a need for methods suitable to produce rotary acoustic horns with more complex internal cavities to enable greater flexibility and control over the vibrational profile across the weld face. There is a need for methods suitable to produce rotary acoustic horns with minimal gaps at the weld face without the weak interfaces arising from the use of non-integral shells, i.e., shells that are bonded or mechanically fastened to the horn.

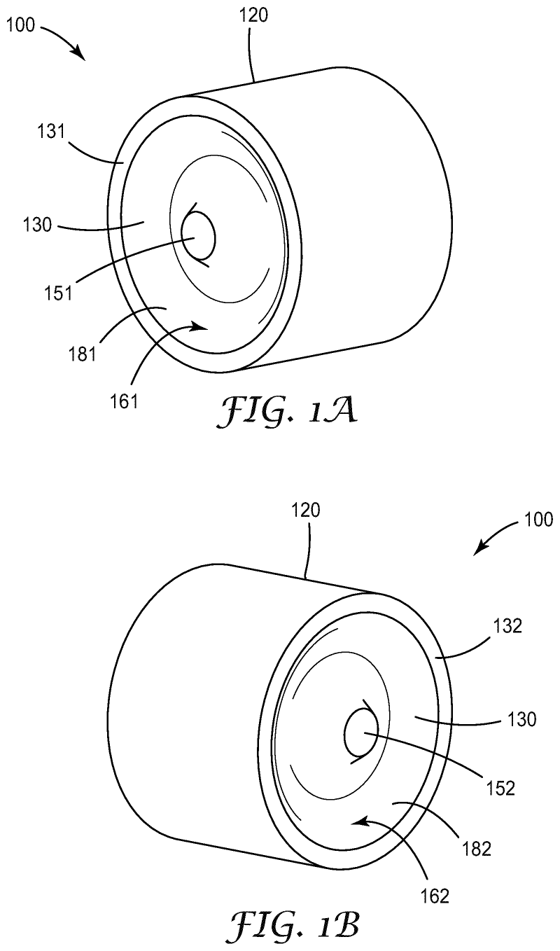

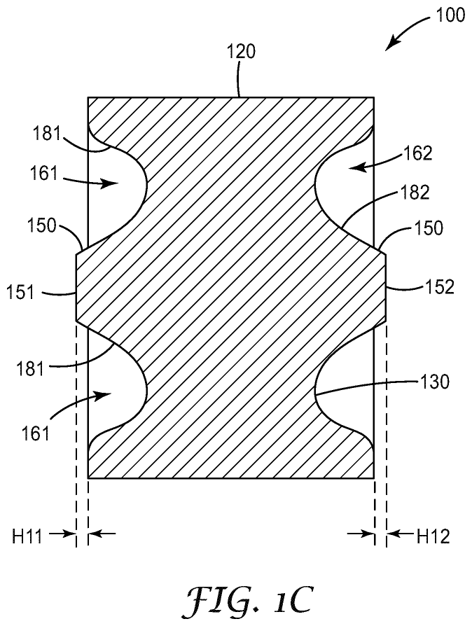

The present invention provides methods of making a unitary rotary acoustic horn comprising metallurgically fusing a first horn segment to a second horn segment. Referring to FIGS. 1A-1C , first horn segment 100 comprises first shaft 150 having first axial input end 151 and first axial output end 152. First horn segment 100 further comprises first horn core 130 comprising first circumferential welding surface 120 extending from first end surface 131 and second end surface 132. As shown, first end surface 131 is the end surface of first horn core 130 closest to first axial input end 151 of first shaft 150, while second end surface 132 is the end of first horn core 130 that is closest to first axial output end 152 of first shaft 150.

First horn core 130 is mechanically coupled to first shaft 150. In some cases, the first horn core is integral with the first shaft, i.e., they are portions of a common structure. For example, in some cases, the horn core and shaft may be made by machining a single, one-piece structure. In some cases, the first horn core may be mechanically mounted, e.g., compression fit, to the first shaft.

Although not required, in some cases the first axial input end 151 of first shaft 150 extends a distance H11 beyond first end surface 131 of first horn core 130. For example, in some cases, the distance H11 and the mass of that portion of shaft 150 may be selected to provide the desired overall length and gain of the final acoustical tool. Similarly, in some cases, the first axial output end 152 of first shaft 150 extends a distance H12 beyond second end surface 132 of first horn core 130. For example, as discussed below, in some cases these distances may be selected to control the gap between the welding surfaces of adjacent horn segments.

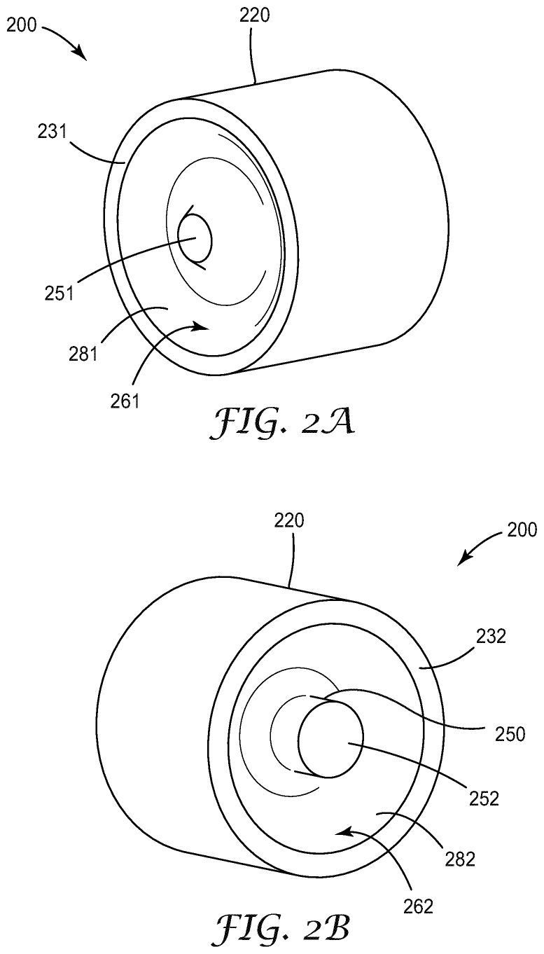

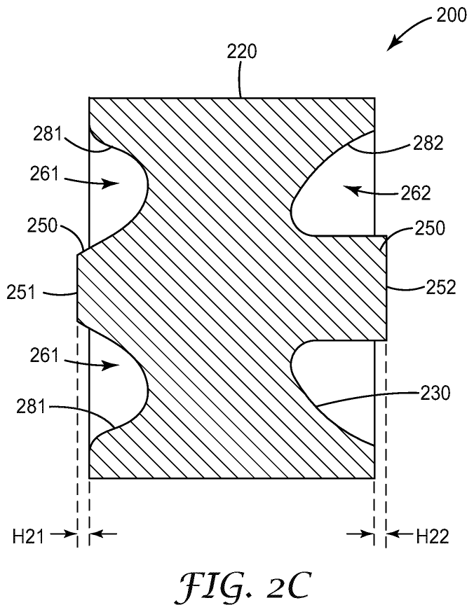

Referring to FIGS. 2A-2C , second horn segment 200 comprises second shaft 250 having second axial input end 251 and second axial output end 252. Second horn segment 200 further comprises second horn core 230 comprising second circumferential welding surface 220 extending from first end surface 231 to second end surface 232. As shown, first end surface 231 is the end surface of the second horn core closest to second axial input end 251 of second shaft 250, while second end surface 232 is the end of the second horn segment that is closest to second axial output end 252 of the second shaft. Second horn core 230 is mechanically coupled to second shaft 250. In some cases, the second horn core is integral with the second shaft. In some cases, the second horn core may be mechanically mounted to the second shaft, e.g., compression fit to the second shaft.

Although not required, in some cases the second axial input end 251 of second shaft 250 extends a distance H21 beyond first end surface 231 of second horn core 230. Similarly, in some cases, the second axial output end 252 of second shaft 250 extends a distance H22 beyond second end surface 232 of second horn core 230.

One or both end surfaces of a horn segment may include cavities or undercuts. Referring to FIGS. 1A to 1C, first end surface 131 of first core 130 may be formed to include one or more cavities, such as cavity 161, while second end surface 132 of first core 130 may be formed to include one or more cavities, such as cavity 162. Similarly, referring to FIGS. 2A to 2C, in some cases, first end surface 231 of second core 230 may be formed to include one or more cavities, such as cavity 261, while second end surface 232 of first core 230 may be formed to include one or more cavities, such as cavity 262. As these cavities can be formed (e.g., molded or machined) prior to metallurgically fusing the first horn segment to the second horn segment, the numbers, locations and shapes of the cavities are not particularly limited.

This offers significant design flexibility in tailoring the vibration amplitude across the weld faces of the resulting acoustic horn.

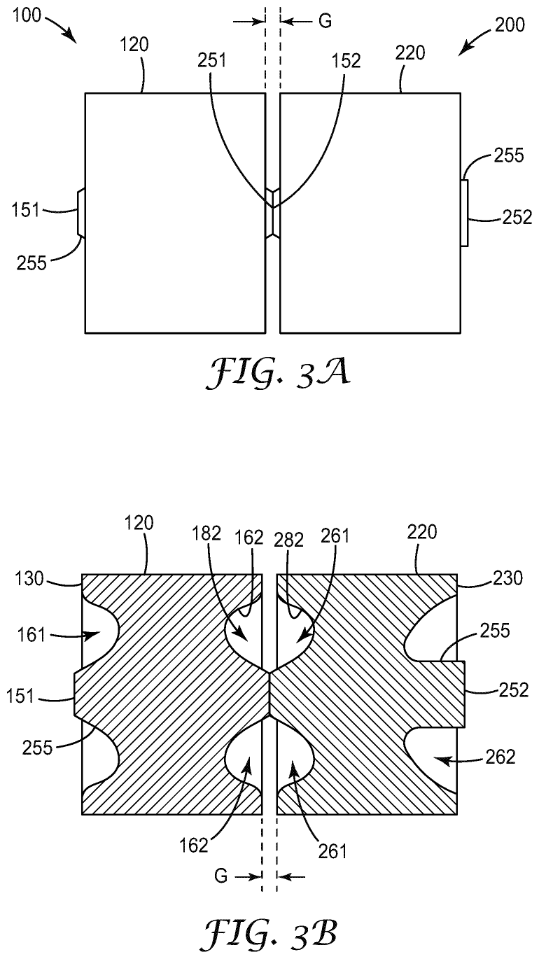

Referring to FIGS. 3A and 3B, in the methods of the present disclosure, first horn segment 100 is integrally bonded to second horn segment 200 by metallurgically fusing the first axial output end 152 of the first shaft to the second axial input end 251 of the second shaft to form integral shaft 255 comprising first shaft 150 metallurgically fused to second shaft 250. Integral shaft 255 retains first axial input end 151 and second axial output end 252 previously associated with the first and second shafts, respectively. In some cases, a portion of the second end surface of the first horn core is metallurgically fused to a portion of the first end surface of the second horn core (not shown).

Exemplary methods of metallurgically fusing include hot isotactic pressing (HIP and friction welding. Hot isostatic pressing involves placing a material in a high-pressure vessel filled with inert gas. The material is subjected to high temperatures and pressures, which compresses and strengthens it while also eliminating any defects or voids. This process is often used to improve the properties and performance of metals, ceramics, and composites.

Friction welding is a solid-state welding process that uses friction to generate heat at the weld interface between two workpieces. During the welding process, one workpiece is rotated while the other is held stationary. The heat generated by the friction at the interface softens the material, and when the rotation is stopped, the two workpieces are pressed together to form a bond.

There are several advantages of metallurgically fusing the horn segments together as compared to the use of mechanical attachment such as the use of threaded fasteners or studs. For example, as the end faces of adjacent shafts are fused along their entire surfaces, it is easier to transmit motion directly instead of relying on the compressional force of a threaded stud. The machined (e.g., drilled and tapped) holes used with mechanical fasteners are often stress concentrators that can eventually lead to horn failure due to cracking. Metallurgical fusion such as hot isostatic pressing and friction welding can be use without the need to create such stress concentrating holes. Also, metallurgical fusion can be used to permanently bond multiple parts made from materials that are difficult to machine.

Hot isostatic pressing can be used with a broader range of geometries, while some forms of friction welding, such as spin welding, may be limited to cylindrical geometries. However, hot isostatic pressing may require an additional material at the metallurgical interface where horn segments are joined. Friction welding may give greater control over the final location of the weld faces and the dimensions of the gaps between horn segments. In addition, friction welding creates an isolated region of high temperature at the zone where the segments are friction welded. In contrast, in hot isostatic pressing, the entire segments will be heated to very high temperatures, and may have to be re-heat treated to obtain the desired mechanical properties. As a result, friction welding may be preferred in some cases.

Another advantage of metallurgical fusion is that the locations of metallurgical fusion relative to the nodes and antinodes of the axial input vibrations are not limited, while threaded studs are positioned at the axial antinode to provide the greatest ability to transmit the axial vibrations. For example, for an acoustic horn having a horn material wavelength of L, the axial output end surface of one shaft may be metallurgically fused to the axial input end surface of an adjacent shaft at a distance of at least L/16 from an axial antinode of the rotary acoustic horn. In some cases, the axial output end surface of one shaft may be metallurgically fused to the axial input end surface of an adjacent shaft at a distance of at least L/8 from an axial antinode of the rotary acoustic horn. In some cases, the axial output end surface of one shaft may be metallurgically fused to the axial input end surface of an adjacent second shaft at distance of no greater than L/32 from an axial node of the rotary acoustic horn.

In some cases, it may be desirable to provide gap G between first weld surface 120 and second weld surface 220. For example, such a gap may facilitate constructions allowing the first and second weld surfaces to vibrate out of phase. In some cases, gap G may be provided by maintaining a distance between first weld surface 120 and second weld surface 220 while metallurgically fusing the first axial output end of the first shaft to the second axial input end of the second shaft. This can be accomplished, in part, by controlling the distances H12 and H21. For example, in the process of metallurgical fusing, the width of gap G can be controlled to some value less than or equal to the sum of H12 and H21. In some cases, gap G may be created or adjusted by machining (for example, grinding or laser ablating) material to form or adjust the width of the gap after metallurgically fusing the first axial output end of the first shaft to the second axial input end of the second shaft.

Referring to FIG. 3B, in some cases the cavities on adjoining end surfaces of adjacent horns can be aligned prior to or while metallurgically fusing the shafts. For example, cavity 162, defined by cavity wall 182 in the second end surface of first horn core 130, may be aligned with cavity 261, defined by cavity wall 281 in first end surface 231 of second horn core 230. Then, when the first and second shafts are metallurgically fused, cavity 162 and cavity 261 will collectively form an internal chamber bounded by cavity walls 182 and 281. In some cases, the internal chamber may be fluidly connected to gap G creating an open chamber, i.e., a chamber fluidly connected to the external atmosphere.

Alternatively, the internal chamber may be fluidly isolated from the gap and will be a closed chamber.

As a gap between adjacent weld surfaces can lead to gaps in ultrasonic welds produced, it may be desirable to minimize the width of the gap as measured parallel to the shaft. In some cases, the width of the gap is no greater than 5000 microns, e.g., no greater than 1000 microns, no greater than 200 microns, or even no greater than 100 microns. In some cases, the width of the gap is at least 10 microns, at least 25 microns, or even at least 40 microns. In some cases, the width of the gap between the first welding surface and the second welding surface is from 10 to 5000, 40 to 5000, 40 to 1000 or even 40 to 100 microns, inclusive.

Generally, such narrow gaps are too small to allow typical machining tools to pass through the gap and to be aligned to form internal chambers. However, using the methods of the present disclosure, a wide variety of chamber dimensions may be formed while retaining the desired narrow gaps in the weld face, or even with no gap.

In some cases, only two horn segments are required to form a single, integral horn. For example, in some cases the structure shown in FIGS. 3A and 3B may be designed to function as a horn having a wavelength of nL/2, where L is the horn material wavelength and n is an integer. The structure depicted in FIGS. 3A and 3B is not drawn to scale; therefore, the axial lengths of the first horn portion and the second horn portion do not have to be equal and can have any ratio.

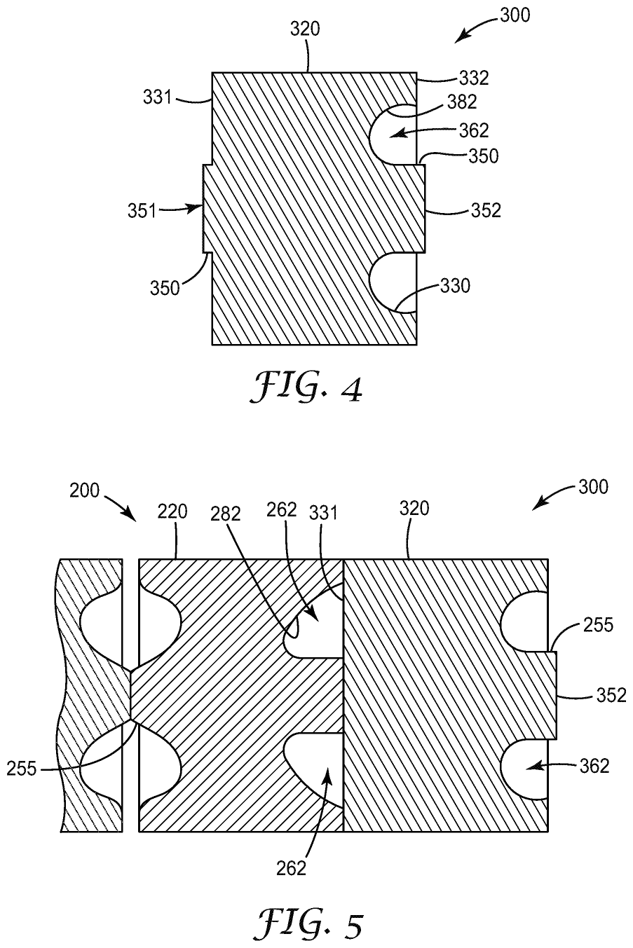

In some cases, the methods of the claimed invention can be used to metallurgically fuse additional horn segments to the first and second horn segments with all segments collectively forming a single, integral horn. For example, referring to FIG. 4, third horn segment 300 comprises third shaft 350 having third axial input end 351 and third axial output end 352. Third horn segment 300 further comprises third horn core 330 comprising third circumferential welding surface 320 extending from first end surface 331 to second end surface 332. As shown, first end surface 331 is the end surface of the third horn core closest to third axial input end 351 of third shaft 350, while second end surface 332 is the end of the third horn segment that is closest to third axial output end 352 of the third shaft.

Third horn core 330 also includes optional cavity 362 bounded by cavity wall 382 of second end surface 332. One or more cavities may also be provided in first end surface 331. However, this is not necessary and first end surface 331 does not comprise any cavities.

Third horn core 330 is mechanically coupled to third shaft 350. In some cases, the third horn core is integral with the third shaft. In some cases, the third horn core may be mechanically mounted to the third shaft, e.g., compression fit to the third shaft.

The third horn segment can be mechanically bonded to the first or second horn segment. For example, in some cases, the third axial output end of the third shaft of the third horn segment can be metallurgically fused to the first axial input end of the integral shaft formed when the first and second horn segments were metallurgically fused. Referring to FIG. 5, in some cases the second axial output end of integral shaft 255 can be metallurgically fused to the third axial input end of the third shaft of the third horn segment to extend integral shaft 255. As a result, third axial output end 352 of third shaft 350 becomes the axial output end of integral shaft 255.

In some cases, the cavity on one end surface may not have a corresponding cavity on the end surface of its adjacent horns or may not be aligned with such a cavity. For example, cavity 262 in the second end surface of the second horn core of horn segment 200 has no corresponding cavity in the first end surface of the third horn core of the third horn segment 300. When the second and third shafts are metallurgically fused, cavity 262, bounded by cavity wall 282, and first end surface 331 of third horn core 330 will form an internal chamber. That is, the internal chamber will be bounded by cavity wall 282 and a portion of first end surface 331 of the third horn core.

In some cases, the internal chamber may be fluidly connected to a gap between the second and third welding surfaces creating an open chamber, i.e., a chamber fluidly connected to the external atmosphere. Alternatively, as shown in FIG. 5, a portion of the second end surface of the second horn segment may be metallurgically fused to a portion of the first end surface of the third horn segment, sealing the internal chamber from the environment forming a closed chamber. As a result, second weld surface 220 and third weld surface 330 for a continuous weld surface with no gaps. Thus, the methods of the present disclosure can be used to form closed chambers without the use of shells mounted to the outer circumference of the horn segments providing greater design flexibility and further enabling creative approaches to controlling the amplitude profile across the weld face.

Assuming no further horn segments are used, the resulting integral horn 500 then includes first horn segment 100, second horn segment 200 and third horn segment 300. Of course, integral horns may be formed from more than three segments following a similar process.

1. A method of making a rotary acoustic horn comprising metallurgically fusing a first horn segment to a second horn segment; wherein
the first horn segment comprises a first shaft having a first axial input end surface and a first axial output end surface, and a first horn core mechanically coupled to the first shaft; wherein the first horn core comprises a first circumferential welding surface integral to the first horn core, a first end surface, and a second end surface, wherein the second end surface of the first horn core comprises a first cavity defined by a first cavity wall; and
the second horn segment comprises a second shaft having second axial input end surface and a second axial output end surface, and a second horn core mechanically coupled to the second shaft; wherein the second horn core comprises a second circumferential welding surface integral to the second horn core, a first end surface, and a second end surface;
wherein metallurgically fusing the first horn segment to the second horn segment comprises metallurgically fusing the first axial output end surface of the first shaft to the second axial input end surface of the second shaft to form an integral shaft and metallurgically fusing at least a portion of the second end surface of the first horn core to at least a portion of the first end surface of the second horn core.

2. The method of claim 1, wherein the first horn core is integral with the first shaft.

3. The method of claim 1, wherein the first horn core is compression fit to the first shaft.

4. The method of claim 1, further comprising metallurgically fusing a third horn segment to either the first horn segment or the second horn segment; wherein
the third horn segment comprises a third shaft having a third axial input end surface and a third axial output end surface, and a third horn core mechanically coupled to the third shaft and comprising a third circumferential welding surface integral to the third horn core; and
wherein metallurgically fusing the third horn segment comprises extending the integral shaft by metallurgically fusing either (i) the second axial output end surface of the second shaft of the second horn segment to the third axial input end surface of the third shaft or (ii) the third axial output end surface of the third shaft of the third horn segment to the first axial input end surface of the first shaft of the first horn segment.

5. The method of claim 1, wherein metallurgically fusing the first axial output end surface of the first shaft to the second axial input end surface of the second shaft comprises friction welding the first axial output end surface to the second axial input end surface.

6. The method of claim 1, wherein metallurgically fusing the first axial output end surface of the first shaft to the second axial input end surface of the second shaft comprises hot isostatically pressing the first axial output end surface to the second axial input end surface.

7. The method of claim 1, wherein the method further comprises forming a hollow chamber bounded by the first cavity wall and a portion of the first end surface of the second horn core when metallurgically fusing the first axial output end surface of the first shaft to the second axial input end surface of the second shaft.

8. The method of claim 1, wherein the first end surface of the second horn core comprises a second cavity defined by a second cavity wall; and
wherein the method further comprises forming a hollow chamber bounded by the first cavity wall and the second cavity wall when metallurgically fusing the first axial output end surface of the first shaft to the second axial input end surface of the second shaft.

9. The method of claim 1, wherein the rotary acoustic horn has a horn material wavelength of L, and the first axial output end surface of the first shaft is metallurgically fused to the second axial input end surface of the second shaft at a distance of at least L/16 from an axial antinode of the rotary acoustic horn.

10. The method of claim 9, wherein the first axial output end surface of the first shaft is metallurgically fused to the second axial input end surface of the second shaft at a distance of at least L/8 from an axial antinode of the rotary acoustic horn.

11. The method of claim 9, wherein the first axial output end surface of the first shaft is metallurgically fused to the second axial input end surface of the second shaft at a distance of no greater than L/32 from an axial node of the rotary acoustic horn.

12. The method of claim 1, wherein the rotary acoustic horn is a half wavelength horn.

13. The method of claim 1, further comprising providing a gap of 40 to 5000 microns between the first welding surface and the second welding surface, as measured parallel to the integral shaft; wherein providing the gap between the first welding surface and the second welding surface comprises machining the gap after metallurgically fusing the first axial output end surface of the first shaft to the second axial input end surface of the second shaft.

14. A rotary acoustic horn made by the method of claim 1.

15. A rotary acoustic horn comprising
a first horn segment comprising a first shaft having a first axial input end surface and a first axial output end surface, and a first horn core mechanically coupled to the first shaft, wherein the first horn core comprises a first circumferential welding surface integral to the first horn core, a first end surface and a second end surface, wherein the second end surface of the first horn core comprises a first cavity defined by a first cavity wall; and
a second horn segment comprising a second shaft having second axial input end surface and a second axial output end surface, and a second horn core mechanically coupled to the second shaft; wherein the second horn core comprises a second circumferential welding surface integral to the second horn core, a first end surface, and a second end surface;
wherein the first axial output end surface of the first shaft is metallurgically fused to the second axial input end surface of the second shaft to form an integral shaft; and at least a portion of the second end surface of the first horn core is metallurgically fused to at least a portion of the first end surface of the second horn core.

16. The rotary acoustic horn of claim 15, wherein the rotary acoustic horn further comprises a hollow chamber collectively formed by the first cavity and a portion of the first end portion of the second horn core.

17. The rotary acoustic horn of claim 15, wherein the first end surface of the second horn core comprises a second cavity, and the rotary acoustic horn further comprises a hollow chamber collectively formed by the first cavity in the second end surface of the first horn segment and the second cavity of the first end portion of the second horn core aligned with the first cavity.

18. The rotary acoustic horn according to claim 15, wherein the rotary acoustic horn has a horn material wavelength of L, and the first axial output end surface of the first shaft is metallurgically fused to the second axial input end surface of the second shaft at a distance of at least L/16 from an axial antinode of the rotary acoustic horn.

19. The rotary acoustic horn of claim 18, wherein the first axial output end surface of the first shaft is metallurgically fused to the second axial input end surface of the second shaft at a distance of at least L/8 from an axial antinode of the rotary acoustic horn.

20. The rotary acoustic horn of claim 18, wherein the first axial output end surface of the first shaft is metallurgically fused to the second axial input end surface of the second shaft at distance of no greater than L/32 from an axial node of the rotary acoustic horn.
